(19) United States
(12) Patent Application Publication
(10) Pub. No.: US 2004/0186721 A1
(43) Pub. Date: Sep. 23, 2004

(54) Apparatus, method and computer program for adding context to a chat transcript

(75) Inventors: Margaret A. R. Beynon, Coventry (GB); Neil Dewhurst, Southampton (GB); Adam D. Iley, Southampton (GB); Andrew D. Reynolds, Southampton (GB)

Correspondence Address: IBM Corporation, IP Law Department, 11400 Burnet Road, Austin, TX, 78758, US

(73) Assignee: INTERNATIONAL BUSINESS MACHINES CORPORATION, ARMONK, NY

(21) Appl. No.: 10/660,063

(22) Filed: Sep. 11, 2003

(30) Foreign Application Priority Data
Mar. 20, 2003 (GB) 0306396.3

(51) Int. Cl. G10L 21/00; G10L 15/18

(52) U.S. Cl. 704/270; 704/275; 704/257

(57) ABSTRACT

The invention relates to an apparatus, method and computer program for adding context to a chat transcript. A message is received which defines at least a part of the chat transcript. The message is then analysed in order that context can be added to it and the modified message is then transmitted to interested parties. Note, the message could for example be modified by assigning a verb thereto and by associating a person with that verb. In this way the chat transcript reads more like a story narrative.

### FIELD OF THE INVENTION

The invention relates to real-time communication.

### BACKGROUND OF THE INVENTION

There are two main kinds of communication using a computer; email and various forms of real-time chat (e.g. using Sametime available from IBM Corporation). Real-time chat systems allow people to type messages to one another and for those messages to appear almost instantaneously on the addressee's display screen. Such systems enable a more natural interaction and discussion to take place than is possible via email.

As users type, their chat system creates a “chat transcript” showing what each user says. The format is typically “name: speech” (e.g. Nicki: What time are you lunching?) Such transcripts typically make dry reading and fail to convey much emotion. This can frequently lead to boredom and misunderstandings. Even if those in the chat are talking about things that they are enthusiastic about or that are important to them, they will rarely produce a chat transcript that they wish to save, much less one that they feel does artistic justice to their topic to the extent that they would share those transcripts with others.

More recent chat systems have tried to make chat transcripts more interesting. For example Microsoft(R) Instant Messenger allows the user to insert “emoticons” to indicate the mood in which something is said. Other systems such as IRC allow the equivalent of stage directions with special commands that insert these directions. For example a user could say “/me laughs heartily” and this would then be rendered by the chat system as “[username] laughs heartily”.

Such systems however require the user to specifically indicate their mood to other users. This is inconvenient since it can often interrupt a user's train of thought. Consequently many users will not bother to add their own emotion to a real-time conversation or will do so rarely. Thus the chat transcript will continue to make dry reading.

U.S. Patent Publication 2002/0005865 discloses a method and device for authoring content for interactive agents. When the agent is authored using this method, it can interact with a user through dialogue and gestures specific to contexts defined by user input, internal states or events of the agent, or input from other systems. The agent may respond to user questions differently when in different moods and the agents mood may change in response to user statements or actions the agent performs. For example, if the user says “I hate New York you moron”, the agent may recognise the keyword “moron” as an insult and therefore get angry. This will be reflected in its responses to the user.

With a real-time conversation between two human-beings, each will have some idea of the mood of the person they are chatting with based on the kinds of words that that person uses. There is a need however to make chat transcripts of such real-time conversations more interesting and fun to read.

### SUMMARY

Accordingly, in a first aspect, the invention provides an apparatus for adding context to a chat transcript, the apparatus comprising: means for receiving a message, defining at least a part of said chat transcript, from a user; means for analysing the text of said message; means, responsive to analysis of the text, for modifying said text in order to add context thereto; and means for transmitting said modified message to interested parties.

It will be appreciated that the addition of context, may actually involve deletion of text from the message.

Preferably the means for modifying the text in order to add context thereto comprises means for assigning a verb to the text; and means for associating the verb with the user from which the message is received. Thus a message of: “Hi. How are you?”. May be modified to read: “Hi. How are you?”, questioned Nicki.

In one embodiment, in order to assign a verb to the text, matches are sought between at least a portion of the text and at least one list. Each item in the list is preferably associated with at least one verb. A verb associated with a matched item is preferably selected. Note, at least one item in a list preferably has a plurality of verbs associated with it. Verbs may also be assigned weightings to determine how often such verbs are assigned.

In one embodiment at least a portion of the text is replaced with an assigned verb. For example, :-) may be replaced with “Nicki smiled.”

In one embodiment, it is possibly to specify at least one predefined rule. This preferably defines how the text should be displayed at a client. Preferably it is possible to instruct the client how to display the text, based on the at least one predefined rule. For example, a rule may specify that if a person has just said something prior to sending the latest message, then this message should be tagged onto the end of their last message.

According to one embodiment, it is possible for a user to indicate their mood. This mood can then be used to influence the context added to the text.

In one embodiment, an adverb is included as part of the context. This adverb is preferably chosen according to the mood indicated by the user.

In one embodiment, the history of a chat transcript is stored. It is preferably possible to update the chat transcript and for any changes to be reflected in the transcript on the display screens of users involved in the chat.

In one embodiment, a user (to whom the text belongs) is informed of the suggested context. The user can then accept or reject the suggested context. Such acceptance/rejection is then acted upon.

In one embodiment, context is assigned based on a predetermined theme. For example, if a historical theme is selected, then verbs such as “spake” and “quoth” may be appropriate.

According to a second aspect, the invention provides a method for adding context to a chat transcript, the method comprising the steps of: receiving a message, defining at least a part of said chat transcript, from a user; analysing the text of said message; responsive to analysis of the text, modifying said text in order to add context thereto; and transmitting said modified message to interested parties.

According to a third aspect, the invention provides a computer program for adding context to a chat transcript, the computer program comprising program code means adapted to perform, when said program is run on a computer, the steps of: receiving a message, defining at least a part of said chat transcript, from a user; analysing the text of said message; responsive to analysis of the text, modifying said text in order to add context thereto; and transmitting said modified message to interested parties.

According to a fourth aspect, the invention provides a client for adding context to a chat transcript, the client comprising: means for receiving a message, defining at least a part of said chat transcript, from a user; means for analysing the text of said message; means, responsive to analysis of the text, for modifying said text in order to add context thereto; and means for transmitting said modified message to interested parties.

According to a fifth aspect, the invention provides a server for adding context to a chat transcript, the server comprising: means for receiving a message, defining at least a part of said chat transcript, from a user; means for analysing the text of said message; means, responsive to analysis of the text, for modifying said text in order to add context thereto; and means for transmitting said modified message to interested parties.

Thus an apparatus, method, computer program, server and client have been described which preferably improve a chat transcript by adding context thereto.

### BRIEF DESCRIPTION OF THE DRAWINGS

A preferred embodiment of the present invention will now be described, by way of example only, and with reference to the following drawings:

FIG. 1 shows an example instant messaging system according to the prior art;

FIG. 2 illustrates an example chat transcript according to the prior art;

FIGS. 3a, 3b and 3c show, according to a preferred embodiment of the present invention, the components and processing involved subsequent to the receipt of an instant message.

### DETAILED DESCRIPTION

Instant Messaging can be implemented in a variety of different ways. Users typically have lists of “buddies” with whom they communicate on a regular basis. Using ICQ, for example, a user contacts an ICQ server in order that the server can determine which of the user's buddies are online. The ICQ server then sends the user the necessary contact details pertaining to the user's online buddies and also ensures that the user is visible to other users. Subsequent communication then takes place directly between the user and another person. The server does not need to become involved in the actual conversation. It is only when a user terminates their session, that their machine informs the ICQ server such that it can alter the user's status to “offline”. Please refer to the Internet site “How Stuff Works” for more information.

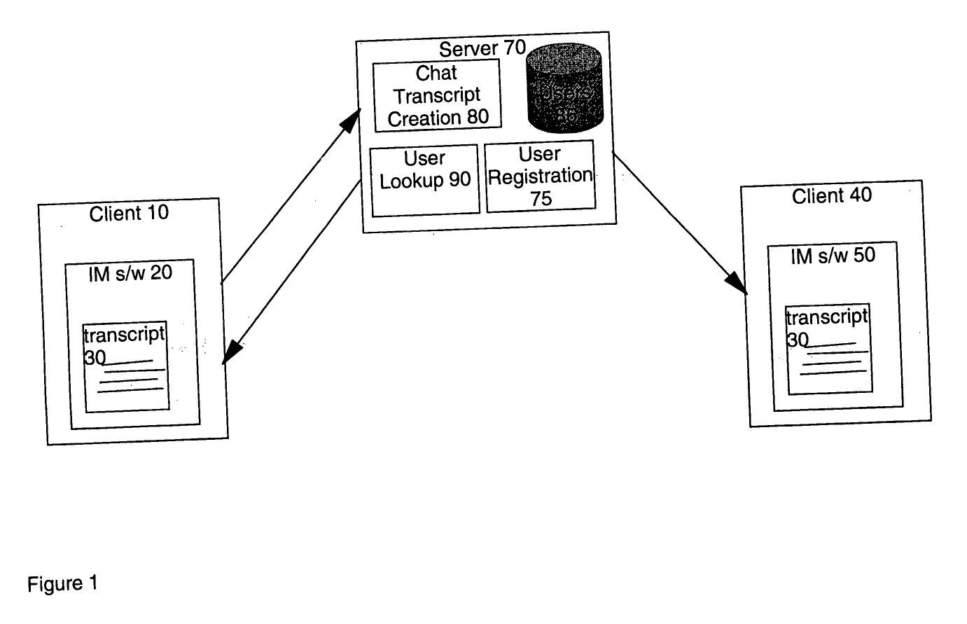

Other messaging systems such as Microsoft Instant Messenger use an intermediary server to forward each message onto the intended recipient. FIG. 1 shows an example of how such a messaging system is implemented.

Clients 10 and 40 are both running instant messaging software 20, 50. If a user of client 10 wishes to communicate in real-time with a user of client 40, client 10 sends an instant message to a central messaging server 70. The instant message contains sender and addressee identification information and server 70 determines whether the sender of the message is known to the server using user lookup component 90 to access a list of known users 85. (Note a user will typically register with the server via user registration component 75 prior to actual use of the instant messaging software.)

Assuming that the user is already known to server 70, the user lookup component 90 and user list 85 is also used to determine whether the addressee of the message is known to the server. Again assuming that the addressee is known, the chat transcript creation component 80 creates a new chat transcript. The server adds to the transcript in the form [username]: [text of instant message]. This information is then forwarded onto client 40 for display via that client's instant messaging software 50. The same information is also forwarded to client 10 for display via that client's instant messaging software 20. If a user of client 40 then replies to the message, the server 70 creates a new line of text according to the same format described above and forwards this to both clients 10, 40. Each client may then use the information received to add to the chat transcript and to display this to the client's user.

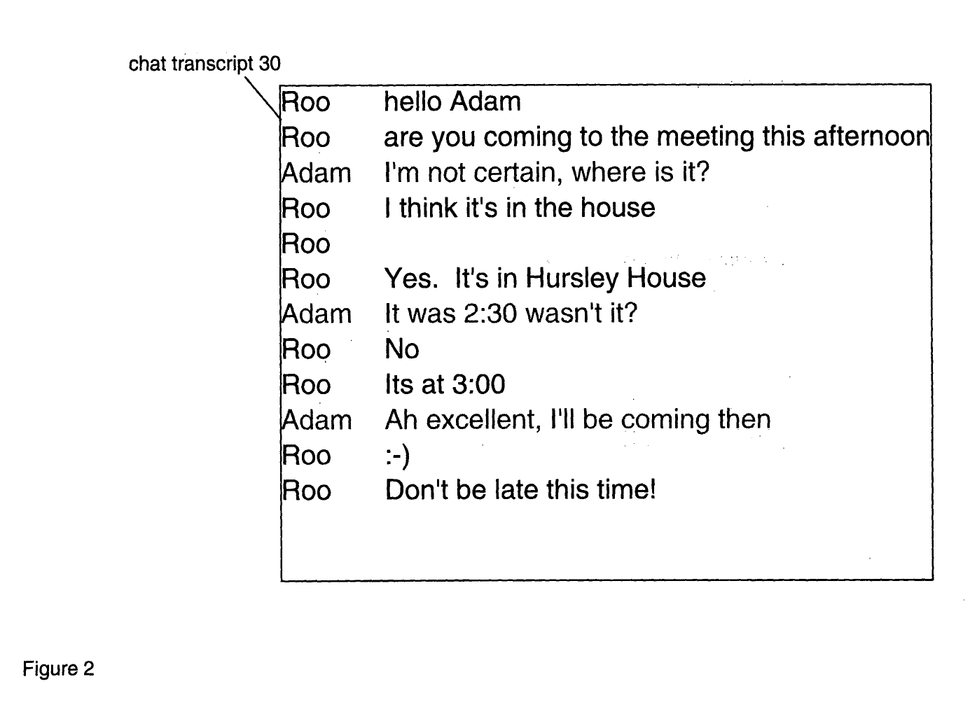

FIG. 2 shows an example of a chat transcript 30 according to the prior art. As discussed above, such a transcript does not make particularly interesting reading. There is no emotion or context.

The present invention therefore preferably adds such context and emotion to a chat transcript. For example the chat transcript of FIG. 2 may be rendered as follows:

“hello Adam”, greeted Roo, “Are you coming to the meeting this afternoon?”

“I'm not certain, where is it?”, Adam pondered

“I think it is in the house”, He paused for a moment,

“Yes. It's in Hursley House.”

“It was 2:30 wasn't it?”

“No”. Roo said, “It's at 3:00.”

“Ah, excellent, I'll be coming then.”

Roo grinned, “Don't be late this time!”

Such a transcript is far more interesting rendered in this way.

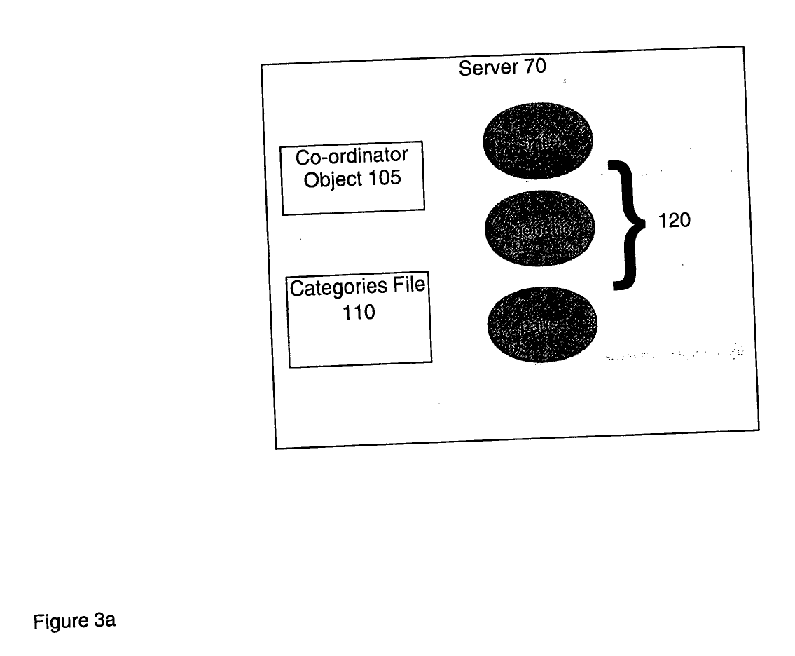

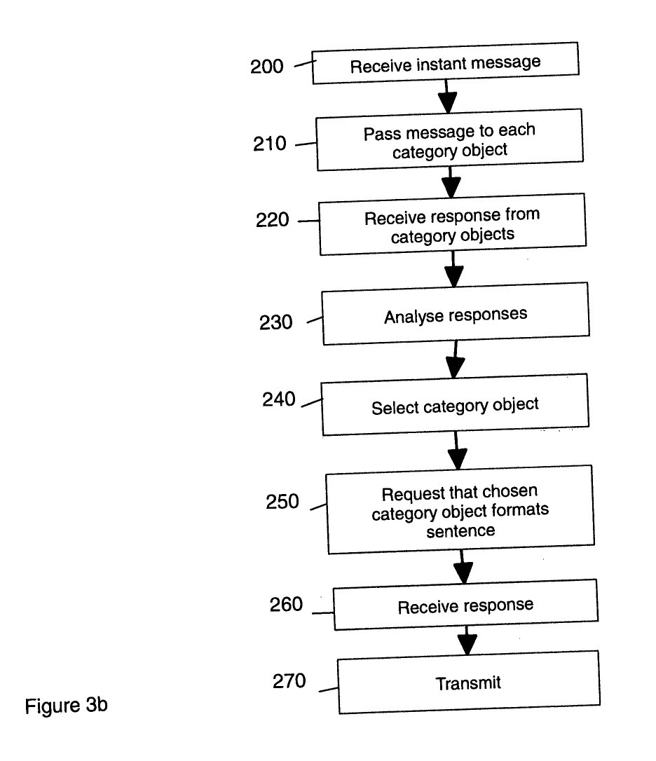

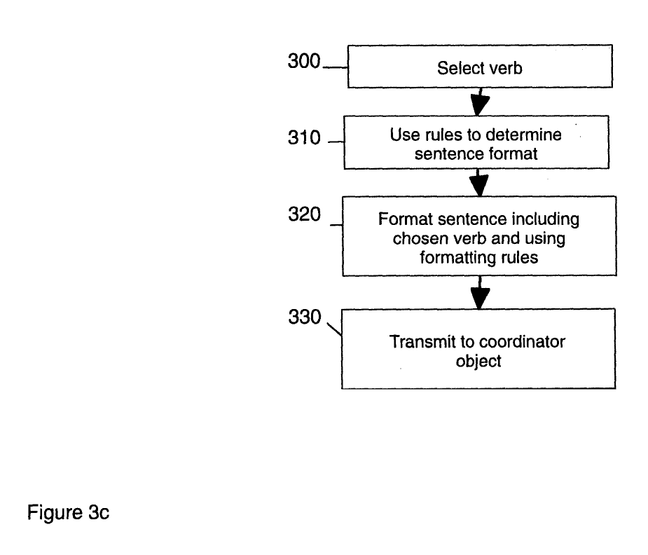

FIG. 3a shows how the system is preferably implemented as a set of objects (using an object-orientated programming language such as Java™). Server 70 comprises a co-ordinator object 105, a categories file 110 (appendix A), and a number of categories objects 120. Each categories object corresponds to a category in the categories file 110. The categories file is used to initialise the relevant category object (e.g. the data in the smile category is used to initialise the smile object).

Thus upon system start-up, the co-ordinator object 105 initialises the category objects 120 with appropriate data from the categories file 110.

The categories file comprises a number of different categories pertaining to the different ways in which a user may say something. The categories of the preferred embodiment are shown in appendix A in bold. They are:

1. generic

2. repeat

3. greeting

4. pause

5. coo

6. laugh

7. smile

8. wink

9. question

10. exclaim

11. disagreement

12. agreement

13. conclude

14. explain

15. decide

16. suggest

17. whisper

18. enthuse

Each category lists the words a user might say and corresponding verbs that might add context based on what they have said.

The format of the categories file is:

(i) category name;

(ii) verbs to add context (separated by commas);

(iii) weightings;

(iv) words found in the sentence;

(v) words the sentence starts with; and

(vi) blank line

Each category object is initialised with its data.

FIG. 3b shows an overview of the processing performed by co-ordinator object 105.

The co-ordinator object 105 receives an instant message (step 200) and passes it to each category object 120 (step 210). Each category object 120 will then compare each word in the sentence of the instant message with the initialisation data acquired from the categories file (i.e. (i) to (vi) for the appropriate category)

For example the co-ordinator object may pass each category object the following sentence “When is the project meeting scheduled for?”). The “question” category object will provide some matches (see extract below):

question

pondered, questioned, queried, asked, wondered, enquired, demanded, requested,

puzzled

1, 1, 1, 1, 1, 1, 1, 1, 1

?

how, why, when, where, is, what, who

Not only does the sentence include a “?”, but it also starts with “When”. It is therefore likely that the user is posing a question.

Each category object will then return a response to the co-ordinator object based on its analysis (step 220). If no word matches are found by an object, then the response will be a value of 0. The question category object will, in the preferred embodiment, return a response of 2 to the co-ordinator object since it found two matches (? And when). It is also possible that other objects will return hits (i.e. values of greater then zero). The co-ordinator object is responsible for analysing the responses and for selecting a category object based on such analysis (step 230, 240). The co-ordinator object preferably chooses randomly from those category objects that returned equal highest numerical values.

Sometimes a person will use words that are not applicable found by any of the category objects. For such cases there is a generic category object. The generic category object will always return a response of greater than zero to the coordinator object. This object is preferably disregarded if other objects have also returned values of greater than zero.

The majority of category objects preferably behave in a similar fashion. However there are some exceptions. Sometimes a person will repeat themselves, in which case the repeat category object will apply. This object compares the message received with a history it keeps of all other messages forming part of a chat transcript. The repeat category object preferably determines that the sentence is a repeat by looking for an exact match of an earlier sentence said by the same user (of course a user may also repeat something said by a different user). A response by the repeat category object may, on one embodiment, always be rated higher than responses from other objects (although this does of course not have to be the case).

In the example above, object 105 ranks the response from the question category object most highly. The co-ordinator object then requests that the chosen category object (in this case the question category object) determine how the sentence should be formatted (step 250). (Note, this stage in the process will be explained in more detail below.) A formatted response is received from the category object (step 250) and is transmitted to the user (step 260).

FIG. 3c illustrates the processing performed by the selected category object in accordance with a preferred embodiment.

The selected category object (in this case the question category object) selects a verb to associate with the message (step 300). This may be a random selection. However, in the preferred embodiment, the categories file is used to initialise the category objects with weighting information. Thus the selection may be based on such information. For example the generic category object details words such as “quoth”, “spake” and “said”. “Quoth” and “spake” are not commonly used and so are given a lower weighting than the word “said”. Such words may, for example, only be used if all the other words in that category have been used more than a predetermined number of times. (This can be tracked.)

In this example, the system might choose the verb “enquired”.

Having selected a verb, the category object applies formatting rules with which it is associated (step 310, 320). Examples of such rules are shown in appendix B. As described in appendix B, a sentence can be structured in one of three ways:

1. person; verb; speech

2. speech; verb; person

3. speech; person; verb

The category object knows the name of the sender of the message since that person will have registered with server 70 and identification information is provided in the message received from the co-ordinator object 105. The category object selects one of the options listed above.

If for example the second choice of sentence structure is selected (i.e. speech; verb; name) and the verb “enquired” is selected from the categories file 210, then the following sentence is created:

“When is the project meeting scheduled for?”, enquired Nicki.

It will be appreciated that according to the choice provided, the system may also create:

Nicki enquired, “When is the project meeting scheduled for?” (selection 1); or

“When is the project meeting scheduled for?”, Nicki enquired (selection 3).

A category object preferably makes a random selection from the three options and may even store a history of selections in order that the transcript is varied. (Category objects may inform other category objects of their selections.) This makes the chat more interesting to the parties involved.

According to the rules specified for the category object quotes and punctuation are typically also added.

The reformatted message is then transmitted to the co-ordinator object (step 330).

Note, category objects also preferably keep track of who the last message was from. Thus if a person was already speaking, then the particular category object responsible for formatting the current message informs the co-ordinator object 105 that the clients involved in the conversation should add the new message to what that person already said (i.e. without a hard return). The coordinator object then passes this onto the clients.

If the person was the second last person to speak (again each category object keeps track of this since it receives each message from the co-ordinator object), the relevant category object may probabilistically decide not to mention that person by name. If this is the case, the name inserted by the relevant category object is replaced with he or she (as appropriate). Each category object can determine such information by accessing a database (not shown) detailing the typical gender of each name registered with it.

Thus the selected category object typically uses the information gained from rules associated with it (e.g. those shown in appendix B) and also from the categories file (appendix A) to reformat the sentence and consequently insert context.

The newly formatted sentence is then transmitted back to the co-ordinator object.

It will be appreciated that the above are only examples of the kinds of categories and rules that can be used to add emotion, context and consequently interest to a chat transcript.

A more detailed example of the processing of the present invention according to a preferred embodiment will now be described with reference to part of the chat transcript of FIG. 2.

A message, “hello Adam”, is received at server 70 from Roo (determined from sender identification information contained in Roo's message). The message is addressed to Adam (information also contained in Roo's message).

The message is passed by the server to co-ordinator component 105 (step 200) which, in turn, passes this message to each of the category objects 120 associated with the server (step 210).

Each category object compares the words “hello” and “Adam” from the message with the category information it holds from the category file and returns its response for receipt by the co-ordinator object 105 (step 220). Naturally the generic object returns a response of 1, but so does the greeting category object (see Appendix A). The other category objects return responses of 0 to the co-ordinator object. The responses from all the category objects are analysed (step 230). A response of 1 or more from an object other than the generic object automatically results in the generic category being overrided. Thus the co-ordinator object selects the greeting category object (step 240). The co-ordinator object 105 requests that the greeting category object format the message (step 250). This object randomly selects a verb from its list of associated verbs (step 300). In this case, the verb “greeted” is selected. The object then looks, at step 310, to the rules associated with it (such as those shown in Appendix B). It randomly selects a sentence structure—for example, speech, verb, person (option 2) and also adds quotation marks and other punctuation as appropriate. The first letter of the sentence is also capitalised (step 320). Thus the resulting formatted message now looks as follows:

“Hello Adam.”, greeted Roo.

This is then transmitted to the co-ordinator object 105 (step 330) which will then transmit the message (step 270) to the clients involved in the conversation.

The next message received at co-ordinator object 105 (step 200) is also from Roo:

are you coming to the meeting this afternoon?

Again the co-ordinator object passes this message to all category objects 120 associated with the system (step 210). Each category object analyses the message for word matches and returns its response to the co-ordinator object (step 220). In this example the generic category object returns a response of 1 (as would be expected) and the question category object responds with a value of 2 (due to a match of “Are” and also “?”). The other objects have return values of 0. Thus the co-ordinator object requests that the question category object format the message appropriately (step 230, 240).

At step 300, the question category object assigns a verb to the message (for example “questioned”). It then examines rules associated with it (step 310). These rules specify for example that if this is a consecutive message from an user, then (i) it is not always necessary to mention them by name; (ii) this message should be added to the end of the previous message from that person. Thus the system randomly elects to do as suggested by (i) and (ii). Other rules indicate that the first letter of the sentence should be capitalised and that punctuation and quotation marks should be added. Thus the message is reformatted (step 320) to read:

“Are you coming to the meeting this afternoon?”

This message is transmitted (step 330) to the co-ordinator object with the instruction that the clients should add this to the end of the previous sentence (without starting a new line). The co-ordinator object receives this message (step 260) and forwards it onto the clients for them to display (step 270).

Adam then replies with the message:

I'm not certain, where is it?

The co-ordinator object receives this message (step 200) and passes this onto the category objects which analyse the message for matches (step 210). Once again, the question category object and the generic object are the only objects to respond with a value of greater than zero. The question category object is selected and the co-ordinator object requests that this object reformat the message (step 220, 230, 240). The question category object randomly selects the verb “pondered” (step 300). The rules associated with this object determine a sentence structure (e.g. speech; person; verb) and that quotes and punctuation should be added (step 310, 320) Since Adam has not previously spoken, an instruction to start this sentence on a new line is associated with the reformatted message. The complete message:

“I'm not certain, where is it?”, Adam pondered.

is then transmitted to the co-ordinator object (step 330) for forwarding to the clients (step 270).

Roo then replies:

I think it's in the house

Once again the co-ordinator object receives this message (step 200) and passes this message to all the category objects (step 210). The only positive response received is from the generic category object (step 220). Thus the co-ordinator object analyses the responses (step 230) and requests that the generic category object format the message appropriately (step 240). The generic category object selects the verb “said” (step 300) based on the fact that this has the highest weighting (i.e. is the most natural to use). However the rules (step 310) associated with the generic category object indicate that if the owner of the current message was the second last person to speak, the object may choose not to assign a verb and not to mention them by name. This is the case here and so the verb selected is overwritten. (Note, some rules could be accessed first in order to determine whether it is necessary to assign a verb.) Punctuation is however added and an instruction to start a new line provided. The message is thus created as:

“I think its in the house.”

(step 320).

This is transmitted to the co-ordinator object (step 330) for forwarding to the clients (step 270).

Roo then transmits a blank line message to server 70 for receipt by co-ordinator object 105 (step 200). Coordinator object 105 passes this to the category objects for analysis (step 210). The generic object category and the pause category object return positive responses (step 220). The latter is selected and is requested to reformat the message (step 230, 240). The pause category object selects not just a verb but rather a phrase: “paused for a moment” (step 300). The rules associated (step 310) with this object indicate that if this construction is selected then the structure of the sentence must be person; verb (“Roo paused for a moment” sounds fine, but “paused for a moment Roo” doesn't). The rules also indicate that “he” or “she” may be used randomly instead of a specific name. A database is used to determine that Roo is male. Further the rules specify that since Roo was already speaking, this additional reformatted message can be tagged on the end of the last message from Roo. All this is communicated to the co-ordinator object (step 330) which will then communicate this to the clients (step 270) to produce:

“I think it is in the house.”, He paused for a moment.

Thus the basic processing involved in reformatting messages received from clients should now be understood. The complete transcript as rendered is shown with reference to FIG. 2 above.

Further enhancements on the basic principles will now be addressed:

It will be appreciated that there may be occasions when the system selects an inappropriate verb or sentence structure. Thus in one embodiment, the user initiating the message is given the option to overwrite the selection made at the server. For example, the server may transmit the reformatted sentence to that user for confirmation, before transmitting it to the other user(s). Users are also preferably given the option to switch the reformatting off.

In one embodiment, the server stores the history of each real-time chat conversation. Certain users may be given permission to update the stored history and such updates would then be reflected on the display screens of user's involved in the updated chat conversation.

Further, the server may transmit the complete chat transcript to the relevant clients each time it gets updated. Clients/users with appropriate permissions may update the chat transcript locally and then broadcast this to server 70 for it to be forwarded onto the other client(s) involved in the real-time chat.

In one embodiment, each user is given the option to specify their mood. For example a slider could be provided for indicating happiness on a scale of 1 to 10. Such information can then be used to dynamically re-weight verb choices. For example the message “Where are you going!” said by an angry user might demand a verb such as “ranted” from the exclaim category, rather than “questioned” from the question category.

In another embodiment, the specified mood of a user can be used to add appropriate adverbs to a sentence. For example “Where are you going!”, Adam ranted angrily. Thus a separate file may be used to store a list of adverbs categorised according to specified mood.

The present invention can also preferably be used to produce themed chats. The theme chosen may determine the verbs assigned. For example, if a historical theme is selected, then old-fashioned verbs like “spake” and “quoth” may be selected in favour of a word like “said”. In one embodiment, each available theme has a its own category objects. The appropriate objects are then loaded into memory based upon the theme chosen. Alternatively the weightings associated with a single category object may be dynamically adjusted according to the theme chosen. For example “said” would typically have a high weighting and “spake”/“quoth” a lower weighting. However for a historical theme, the weighting could be dynamically adjusted such that they are reversed.

Further for themed chats, agents preferably run on server 70 that can alter the story environment. For example, in a storm setting at sea, perhaps an agent may occasionally insert narrative lines such as “The wind crashed and the waves reared up around the frail looking ship. Those on the deck bravely stood their ground”. Or very occasionally, it could block out what someone said with “Adam's voice was drowned out by the sound of splitting timbers”, and then they'd have to say it again.

According to one embodiment, a narrate function is also provided. This enables a story to be built around a chat. The user can type, for example, /narrate and this then allows them to add some story text without the sentence creator adding in context of its own.

For example, Roo might send:

/narrate Around the open fire, two figures sat, revelling in its warmth, and delighting in its light. The potatoes roasting in the centre of the fire were coming on nicely, and the heat from the fire was a welcome change from the cold of the night.

Adam could then respond “Ah” to which the system might add, quoth Adam. Thus the /narrate function temporarily switches off the addition of context.

It will be appreciated that the rules associated with category objects may be hardcoded or may be in storage associated with the category objects.

Whilst the embodiments described matches on single words in order to assign verbs, a more advanced method could be used. For example, regular expressions as provided by programming languages such as Java™ could be used. Such expressions allow more complicated pattern matching to be defined. A more sophisticated approach is to detect any pattern in the text. One way of doing this would be to use regular expressions, which are a common way of detecting patterns. For example, a regular expression to detect some sentences in the passive voice would be “m/(were|had|was)\s+((\w+ed)|made)/”, which will detect any sentence that contains the were or had or was followed by a word ending in “ed” or “made”. For example “Mistakes were made” would be matched by this rule. (Java is a trademark of Sun Microsystems Inc. in the United States and/or other countries)

Finally, it will be appreciated that whilst the main functionality of the present invention has been described as residing on the server, this does not have to be the case. For example, each client could have the appropriate means for adding context to any speech uttered by its user.

Appendix A

We start with the generic ones, that are always applicable.

The format is

moodname

words (separated by commas)

weightings

blank line

generic

said, spake, quoth, uttered, remarked, commented

1, 3, 3, 1, 1, 1

Then the ones if a sentence is repeated

same format as above.

repeat

repeated, reiterated, echoed, emphasised

1, 1, 1, 1

now the general ones.

format is:

moodname

words (separated by commas)

weightings

words found in the sentence

words the sentence starts with

blank line

Repeat above for each mood. Then, the last line of the file should read “done”

done

greeting

greeted

1

hi, hello, howdy, yo

pause

paused, paused for a moment

2, 1

. . .

[blank line]

coo

cooed

1

ahh, aww

laugh

laughed, chuckled

2, 1

heh, hehe, teehee

smile

smiled, grinned, beamed

2, 1, 1

:-), :), :o), 8-), :-)>

wink

winked

1

;-), ;), ;o)

question

pondered, questioned, queried, asked, wondered, enquired, demanded, requested, puzzled

1, 1, 1, 1, 1, 1, 1, 1, 1

?

how, why, when, where, is, what, who, are

exclaim

spouted, exclaimed, shouted, ranted, raved, came out with, cried, smiled

1, 1, 1, 1, 1, 1, 1, 1

cripes, wow, amazing, astonishing, unbelievable, remarkable, horrendous, scary, idiot, gosh, pah, bah, !

agreement

acknowledged, assented, agreed, concurred, confirmed, corroborated, accepted, affirmed, endorsed, approved, declared, averred

1, 1, 1, 1, 1, 1, 1, 1, 1, 1, 1, 1

ok, yes, certainly, uhuh, correct, definitely

conclude

concluded, summarized, assessed

3, 3, 2

right then

so

explain

explained, clarified

1, 1

because, since, therefore

decide

decided, resolved, determined, declared

1, 1, 1, 1

i will, he will, she will, you will, they will, it will, he shall, she shall

suggest

suggested, proposed

1, 1

how about, what about

whisper

whispered, breathed

1, 1

(

enthuse

enthused, trilled

1, 1

excellent, great, fantastic, cool, fab, superb

done

Appendix B

Use one of the following in structuring a sentence

Make selection randomly

person; verb; speech

speech; verb; person

speech; person; verb

Unless “paused for a moment is selected by pause category object

In this case the format is speech [ie none]; person verb

place quotation marks around speech

Punctuation etc.

if speech; verb; person formatting used

place a comma after the quotes enclosed speech

if the first letter in a sentence is not capitalised, make it so

if a sentence does not end with a fullstop

add one

if a person was the second last to speak

do not always mention them

do not always assign verb

if a person was already speaking

add what they said to what they've already said

do no always assign verb

if a person has spoken before and know what sex they are

sometimes use he/she instead of their name

New Line

if new person speaking, start on new line

What is claimed is:

1. Apparatus for adding context to a chat transcript, the apparatus comprising:
means for receiving a message, defining at least a part of said chat transcript, from a user;
means for analysing the text of said message;
means, responsive to analysis of the text, for modifying said text in order to add context thereto; and
means for transmitting said modified message to interested parties.

2. Apparatus of claim 1, wherein said means for modifying the text in order to add context thereto comprises:
means for assigning a verb to the text; and
means for associating the verb with the user from which the message is received.

3. Apparatus of claim 2, wherein the means for assigning a verb to the text comprises:
means for looking for matches between at least a portion of the text and at least one list, each item in a list being associated with at least one verb; and
means for selecting a verb associated with a matched item.

4. Apparatus of claim 3, wherein a plurality of verbs are associated with at least one item in at least one list.

5. Apparatus of claim 4, wherein associated verbs are assigned weightings which determine how often said verbs are assigned by said assigning means.

6. Apparatus of claim 2, wherein the means for assigning a verb to the text comprises:
means for replacing at least a portion of the text with said verb.

7. Apparatus of claim 2, wherein said means for modifying the text in order to add context thereto comprises:
means for defining how the text should be displayed at a client according to at least one predefined rule.

8. Apparatus of claim 7, comprising:
means for instructing said client how to display said text, based upon at least one predefined rule.

9. Apparatus of claim 2 comprising:
means for a user to indicate their mood; and
means for using said indicated mood to influence the context added to said text.

10. Apparatus of claim 9 comprising:
means for including an adverb as part of said context, said adverb chosen according to the mood indicated by the user.

11. Apparatus of claim 1 comprising:
means for storing a history of the chat transcript.

12. Apparatus of claim 11 comprising:
means for updating said stored chat transcript;
means for reflecting any changes in said transcript on the display screens of users involved in the chat.

13. Apparatus of claim 1 comprising:
means for informing a user to whom the text belongs of the suggested context;
means for receiving acceptance or rejection of said suggested context; and
means for acting upon said rejection or acceptance.

14. Apparatus of claim 1 comprising:
means for assigning context based on a predetermined theme.

15. Method for adding context to a chat transcript, the method comprising the steps of:
receiving a message, defining at least a part of said chat transcript, from a user;
analysing the text of said message;
responsive to analysis of the text, modifying said text in order to add context thereto; and
transmitting said modified message to interested parties.

16. The method of claim 15, wherein the step of modifying the text in order to add context thereto comprises:
assigning a verb to the text; and
associating the verb with the user from which the message is received.

17. The method of claim 16, wherein the step of assigning a verb to the text comprises:
looking for matches between at least a portion of the text and at least one list, each item in a list being associated with at least one verb; and
selecting a verb associated with a matched item.

18. The method of claim 17, wherein a plurality of verbs are associated with at least one item in at least one list.

19. The method of claim 18, wherein associated verbs are assigned weightings which determine how often said verbs are assigned.

20. The method of claim 16, wherein the step of assigning a verb to the text comprises:
replacing at least a portion of the text with said verb.

21. The method of claim 16, wherein the step of modifying the text in order to add context thereto comprises:
defining how the text should be displayed at a client according to at least one predefined rule.

22. The method of claim 21, comprising the step of:
instructing said client how to display said text, based upon at least one predefined rule.

23. The method of claim 16 comprising the steps of:
enabling a user to indicate their mood; and
using said indicated mood to influence the context added to said text.

24. The method of claim 23 comprising the step of:
including an adverb as part of said context, said adverb chosen according to the mood indicated by the user.

25. The method of claim 15 comprising the step of:
storing a history of the chat transcript.

26. The method of claim 25 comprising the steps of:
updating said stored chat transcript;
reflecting any changes in said transcript on the display screens of users involved in the chat.

27. The method of claim 15 comprising the steps of:
informing a user to whom the text belongs of the suggested context;
receiving acceptance or rejection of said suggested context; and
acting upon said rejection or acceptance.

28. The method of claim 15 comprising the step of:
assigning context based on a predetermined theme.

29. A computer program for adding context to a chat transcript, the computer program comprising program code means adapted to perform, when said program is run on a computer, the steps of:
receiving a message, defining at least a part of said chat transcript, from a user;
analysing the text of said message;
responsive to analysis of the text, modifying said text in order to add context thereto; and
transmitting said modified message to interested parties.

30. A client for adding context to a chat transcript, the client comprising:
means for receiving a message, defining at least a part of said chat transcript, from a user;
means for analysing the text of said message;
means, responsive to analysis of the text, for modifying said text in order to add context thereto; and
means for transmitting said modified message to interested parties.

31. A server for adding context to a chat transcript, the server comprising:
means for receiving a message, defining at least a part of said chat transcript, from a user;
means for analysing the text of said message;
means, responsive to analysis of the text, for modifying said text in order to add context thereto; and
means for transmitting said modified message to interested parties.
